(19) United States
(12) Patent Application Publication
(10) Pub. No.: US 2016/0273559 A1
(43) Pub. Date: Sep. 22, 2016

(54) FLUID PRESSURE CYLINDER

(71) Applicant: KYB CORPORATION, Tokyo (JP)

(72) Inventor: Yasuhito TAKAI, Aichi (JP)

(73) Assignee: KYB Corporation, Tokyo (JP)

(21) Appl. No.: 15/034,080

(22) PCT Filed: Nov. 12, 2014
(86) PCT No.: PCT/JP2014/079951

§ 371 Date: May 3, 2016

(30) Foreign Application Priority Data
Nov. 25, 2013 (JP) 2013-242981

(51) Int. Cl. F15B 15/22; F15B 15/14

(52) U.S. Cl. CPC F15B 15/22; F15B 15/14

(57) ABSTRACT

A fluid pressure cylinder includes the piston rod having a first tapered portion formed on an outer circumference of the piston rod so as to be inclined with respect to a center axis; a cushion bearing that is provided around the outer circumference of the piston rod; a bearing receiving portion that allows insertion of the cushion bearing; and a cushion passage that is formed between the cushion bearing and the bearing receiving portion when the cushion bearing is inserted into inside of the bearing receiving portion at the vicinity of the stroke end and that imparts resistance to flow of working fluid passing through the cushion passage. The cushion bearing has a contacting portion capable of coming into contacting with the first tapered portion, and the contacting portion is positioned with respect to the piston rod by being brought into contact with the first tapered portion.

### TECHNICAL FIELD

The present invention relates to a fluid pressure cylinder in which a piston rod is decelerated by cushion pressure generated at the vicinity of a stroke end of the piston rod.

### BACKGROUND ART

As conventional fluid pressure cylinders, there is a known fluid pressure cylinder that includes a cushioning mechanism by which a piston rod is decelerated by cushion pressure generated when the piston rod inserted into a cylinder tube comes to the vicinity of a stroke end.

JP1999-230117A discloses a cushioning mechanism including a cylindrical cushion bearing provided around the outer circumference of a piston rod. In this cushioning mechanism, the cushion bearing is inserted into the inside of a cylinder head provided on a cylinder tube, and thereby, resistance is imparted to flow of fluid passing through between the cushion bearing and the cylinder head.

### SUMMARY OF INVENTION

With such a cushioning mechanism, the cushion bearing is generally arranged between a step formed on the piston rod and a piston fastened to a tip end of the piston rod.

There is a case in which a tapered portion is formed on a corner of the step formed on the piston rod in order to ensure an assemblability when the cylinder head is inserted into the piston rod. In such a case, because the step having both a seat surface for positioning the cushion bearing and the tapered portion for ensuring the assemblability is formed on the outer circumference of the piston rod, the difference between an outer diameter of the main body portion of the piston rod and an outer diameter of the tip end side of the piston rod becomes great.

Therefore, a diameter of a screw portion that is formed on the tip end side of the piston rod for fastening the piston cannot be made large, and it is not possible to improve the strength of the piston rod.

An object of the present invention is to improve the strength of a piston rod of a fluid pressure cylinder.

According to one aspect of the present invention, a fluid pressure cylinder in which a piston rod is decelerated by cushion pressure generated at vicinity of a stroke end of the piston rod includes the piston rod having a first tapered portion formed on an outer circumference of the piston rod so as to be inclined with respect to a center axis; a cylinder tube into which the piston rod is inserted; a tubular cushion bearing that is provided around the outer circumference of the piston rod; a bearing receiving portion that allows insertion of the cushion bearing; and a cushion passage that is formed between the cushion bearing and the bearing receiving portion when the cushion bearing is inserted into inside of the bearing receiving portion at the vicinity of the stroke end and that imparts resistance to flow of working fluid passing through the cushion passage. The cushion bearing has, on an inner circumference, a contacting portion capable of coming into contacting with the first tapered portion, and the contacting portion is positioned with respect to the piston rod by being brought into contact with the first tapered portion.

### BRIEF DESCRIPTION OF DRAWINGS

FIG. 1 is a sectional view showing a part of a fluid pressure cylinder according to an embodiment of the present invention.

FIG. 2 is a sectional view showing the fluid pressure cylinder according to the embodiment of the present invention and shows a state in which a piston rod moves in extension direction and comes to the vicinity of a stroke end.

FIG. 3 is a sectional view showing the fluid pressure cylinder according to the embodiment of the present invention and shows a state in which the piston rod moves in contraction direction from the stroke end.

FIG. 4 is a perspective view showing a cushion bearing of a fluid pressure cylinder according to a modification of the embodiment of the present invention.

FIG. 5 is a perspective view showing a cushion bearing of a fluid pressure cylinder according to a modification of the embodiment of the present invention.

FIG. 6 is a sectional view showing a part of a fluid pressure cylinder according to another modification of the embodiment of the present invention.

FIG. 7 is a sectional view showing a part of a fluid pressure cylinder according to another modification of the embodiment of the present invention.

FIG. 8 is a sectional view showing a fluid pressure cylinder according to a comparative example of the embodiment of the present invention.

### DESCRIPTION OF EMBODIMENT

A fluid pressure cylinder 100 according to an embodiment of the present invention will be described below with reference to the drawings. A case in which working fluid of the fluid pressure cylinder 100 is working oil will be described below.

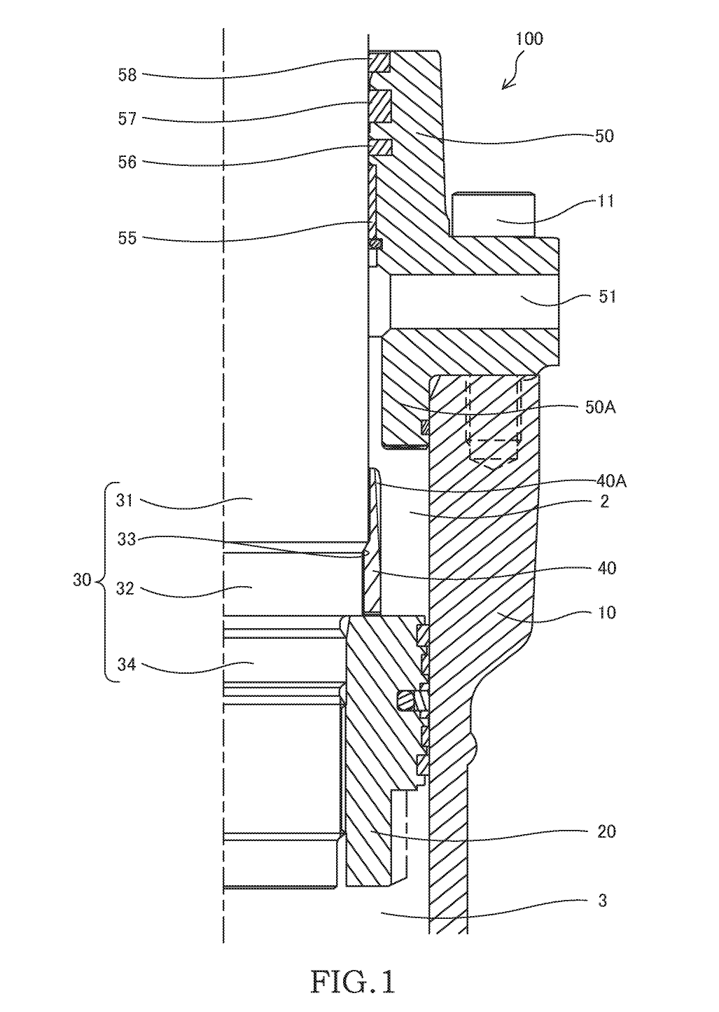

A configuration of the hydraulic cylinder 100 will be mainly described first with reference to FIGS. 1 to 3.

The hydraulic cylinder 100 is, for example, used as an arm cylinder of a hydraulic shovel. An arm of the hydraulic shovel is rotated by extending and contracting the hydraulic cylinder 100.

The hydraulic cylinder 100 includes a tubular cylinder tube 10, a piston 20 that slides along the inner circumferential surface of the cylinder tube 10 and partitions the interior of the cylinder tube 10 into a rod-side chamber 2 and a bottom-side chamber 3, a piston rod 30 that is connected to the piston 20 and inserted into the cylinder tube 10, and a tubular cushion bearing 40 that is provided around the outer circumference of the piston rod 30.

The hydraulic cylinder 100 extends and contracts by movement of the piston rod 30 in the axial direction by working oil pressure introduced to the rod-side chamber 2 or the bottom-side chamber 3 from a hydraulic pressure source (working-fluid pressure source).

A cylindrical cylinder head 50 that slidably supports the piston rod 30 is provided at an opening end of the cylinder tube 10. The cylinder head 50 has a bearing receiving portion 50A that is inserted into the inside of the cylinder tube 10. The cylinder head 50 is fastened to the cylinder tube 10 with a plurality of bolts 11.

A bush 55, an auxiliary seal 56, a main seal 57, and a dust seal 58 are interposed on the inner circumference of the cylinder head 50.

The bush 55 is brought into sliding contact with the outer circumferential surface of the piston rod 30, and thereby, the piston rod 30 is supported so as to be movable in the axial direction of the cylinder tube 10.

A supply/discharge port 51 that is communicated with the rod-side chamber 2 is formed on the cylinder head 50. A hydraulic piping that communicates with the hydraulic pressure source is connected to the supply/discharge port 51.

For ease of understanding the hydraulic cylinder 100, a hydraulic cylinder 200 will be described as a comparative example with reference to FIG. 8. The description will be made using the same reference signs for the same configurations with those of the hydraulic cylinder 100.

A piston rod 130 of the hydraulic cylinder 200 includes a main body portion 131 that is in sliding contact with the inner circumference of the cylinder head 50, a small-diameter portion 132 having a smaller diameter than that of the main body portion 131, a step portion 133 formed between the main body portion 131 and the small-diameter portion 132, and a screw portion 134 that is formed at a tip end of the piston rod 130 and fastened to the piston 20.

The step portion 133 of the piston rod 130 includes a tapered portion 133A that is formed so as to be inclined with respect to the center axis and a vertical portion 133B that is formed so as to be vertical with respect to the center axis and that forms a seat surface of a cushion bearing 140 described below. By providing the tapered portion 133A, when the piston rod 130 is inserted into the cylinder head 50, seal members provided on the inner circumference of the cylinder head 50 are prevented from being caught by the step portion 133 of the piston rod 130. Thus, assembly of the hydraulic cylinder 200 becomes easy. In addition, a stress relief portion 135 is formed between the vertical portion 133B and the small-diameter portion 132 in order to prevent stress concentration at the piston rod 130.

The cushion bearing 140 of the hydraulic cylinder 200 is formed to have an inner diameter larger than an outer diameter of the small-diameter portion 132 of the piston rod 130. The cushion bearing 140 is provided around the outer circumference of the small-diameter portion 132 of the piston rod 130 and between the step portion 133 of the piston rod 130 and the piston 20.

The cushion bearing 140 is formed to have an outer diameter smaller than an inner diameter of the bearing receiving portion 50A of the cylinder head 50. The cushion bearing 140 is inserted into the inside of the bearing receiving portion 50A at the vicinity of a stroke end of the piston rod 130 and forms a cushion passage 105 with the bearing receiving portion 50A. Resistance is imparted to the flow of the working oil passing through the cushion passage 105.

In addition, the cushion bearing 140 is formed so as to be slightly movable in the axial direction between the step portion 133 of the piston rod 130 and the piston 20. The positions of the cushion bearing 140 in the axial direction are determined by contact of the one axial-direction end surface 141 with the piston 20 and contact of the other axial-direction end surface 142 with the vertical portion 133B of the step portion 133 of the piston rod 130. Thus, dropping out of the cushion bearing 140 from the piston rod 130 is prevented.

As described above, the hydraulic cylinder 200 includes the piston rod 130 having the tapered portion 133A and the vertical portion 133B. Therefore, the difference between the outer diameter of the main body portion 131 and the outer diameter of the screw portion 134, which is the tip end of the piston rod 130, becomes large, and it is not possible to increase the diameter of the screw portion 134.

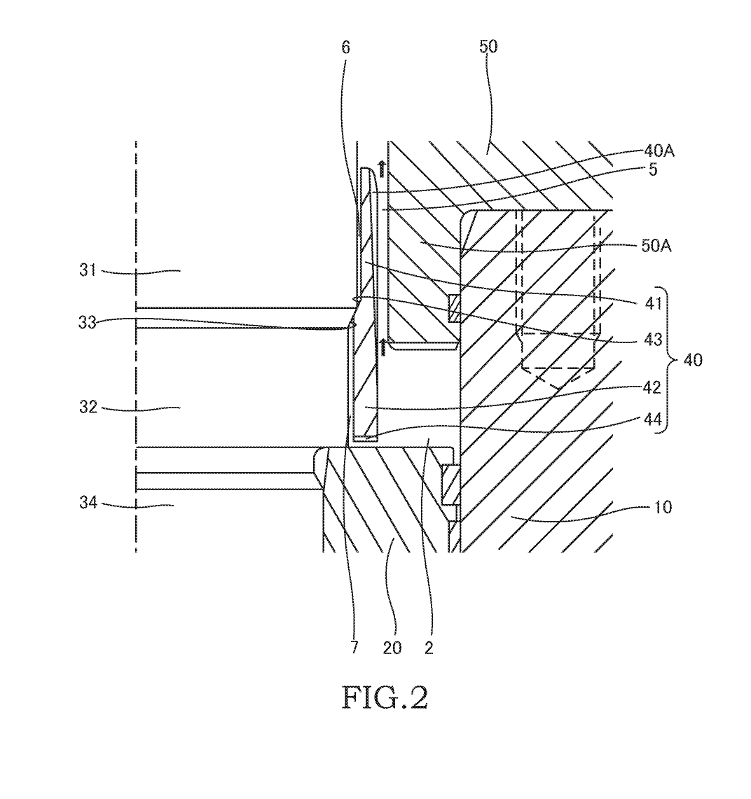

Thus, as shown in FIG. 2, the piston rod 30 of the hydraulic cylinder 100 includes a main body portion 31 that is in sliding contact with the inner circumference of the cylinder head 50, a small-diameter portion 32 having a smaller diameter than the main body portion 31, a first tapered portion 33 that is formed between the main body portion 31 and the small-diameter portion 32 so as to be inclined with respect to the center axis, and a screw portion 34 that is formed at the tip end of the piston rod 30 and to which the piston 20 is fastened.

Because the first tapered portion 33 of the piston rod 30 is formed so as to be inclined with respect to the center axis, when the piston rod 30 is inserted into the cylinder head 50, seal members, such as the auxiliary seal 56, the main seal 57, and the dust seal 58, provided inside the cylinder head 50 are prevented from being caught by the piston rod 30. In other words, the first tapered portion 33 functions as a tapered portion for ensuring the assemblability.

A cushion bearing 40 of the hydraulic cylinder 100 includes an inserted portion 41 that is inserted into the inside of the bearing receiving portion 50A of the cylinder head 50 at the vicinity of the stroke end of the piston rod 30, a positioning portion 42 that is provided between the first tapered portion 33 of the piston rod 30 and the piston 20, and a second tapered portion 43, serving as a contacting portion, that is formed between the positioning portion 42 and the inserted portion 41 on the inner circumference so as to be inclined with respect to the center axis.

On the outer circumference of the cushion bearing 40, a tapered groove 40A is formed so as to inclined with respect to the center axis. The tapered groove 40A is formed such that its depth gradually increases from the piston 20 side of the cushion bearing 40 in the axial direction. Therefore, the tapered groove 40A functions as a variable restrictor that imparts, when the cushion bearing 40 is inserted into the inside of the bearing receiving portion 50A of the cylinder head 50, resistance to the flow of the working oil passing therethrough. The tapered groove 40A may have any shape in accordance with the resistance to be imparted to the flow of the working oil passing therethrough.

The inserted portion 41 of the cushion bearing 40 is formed to have an inner diameter greater than an outer diameter of the main body portion 31 of the piston rod 30. The inserted portion 41 is formed to have an outer diameter smaller than an inner diameter of the bearing receiving portion 50A of the cylinder head 50. As described above, the inserted portion 41 of the cushion bearing 40 is provided so as to form a first inner-circumference gap 6 with the outer circumferential surface of the main body portion 31 of the piston rod 30, and is provided so as to be inserted into the inside of the bearing receiving portion 50A of the cylinder head 50 at the vicinity of the stroke end of the piston rod 30.

The positioning portion 42 of the cushion bearing 40 is formed to have an inner diameter that is greater than an outer diameter of the small-diameter portion 32 of the piston rod 30 but smaller than the outer diameter of the main body portion 31 of the piston rod 30. As described above, the positioning portion 42 of the cushion bearing 40 is provided such that a second inner-circumference gap 7 is formed between the positioning portion 42 and the outer circumferential surface of the piston rod 30.

The positioning portion 42 is formed so as to be slightly movable in the axial direction between the first tapered portion 33 of the piston rod 30 and the piston 20. When the cushion bearing 40 is moved towards the piston 20 side, an end surface of the positioning portion 42 is brought into contact with the piston 20.

On the end surface of the positioning portion 42 on the piston 20 side, a groove portion 44 that extends in the radial direction is provided.

The second tapered portion 43 of the cushion bearing 40 is formed such that the inclined angle of the piston rod 30 relative to the center axis becomes substantially equal to that of the first tapered portion 33 of the piston rod 30. When the cushion bearing 40 is moved to the opposite side from the piston 20, the second tapered portion 43 is brought into contact with the first tapered portion 33 of the piston rod 30. In other words, the first tapered portion 33 of the piston rod 30 functions as a seat surface that determines the position of the cushion bearing 40 in the axial direction. The second tapered portion 43 of the cushion bearing 40 may not be formed to have the inclined angle equal to that of the first tapered portion 33 of the piston rod 30 and the second tapered portion 43 may be formed to have a right-angle step so long as the second tapered portion 43 can be brought into contact with the first tapered portion 33.

As described above, according to the hydraulic cylinder 100, because the first tapered portion 33 of the piston rod 30 functions as the tapered portion for ensuring the assemblability and also as the seat surface of the cushion bearing 40, it is possible to reduce the difference between the outer diameter of the main body portion 31 of the piston rod 30 and the outer diameter of the screw portion 34 on the tip end side.

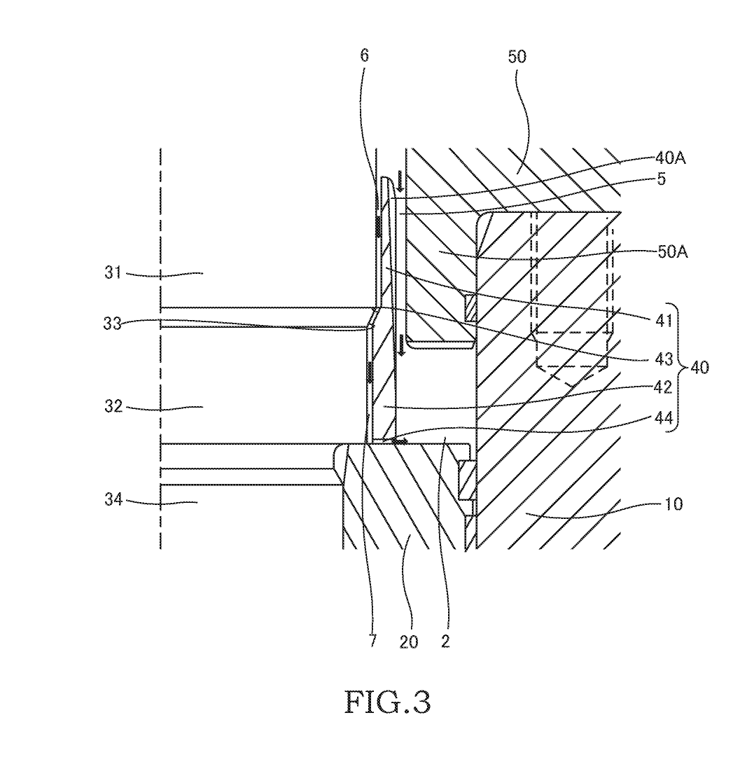

Next, the cushioning operation of the hydraulic cylinder 100 will be described with reference to FIGS. 2 and 3.

FIG. 2 shows a state in which the piston rod 30 moves in extension direction and comes to the vicinity of a stroke end, and FIG. 3 shows a state in which the piston rod 30 moves in contraction direction from the vicinity of the stroke end.

When the bottom-side chamber 3 is communicated with a hydraulic pump and the rod-side chamber 2 is communicated with a tank, because the working oil is supplied to the bottom-side chamber 3 and the working oil in the rod-side chamber 2 is discharged to the tank, the piston rod 30 moves in extension direction.

When the piston rod 30 moves in extension direction, the cushion bearing 40 is moved slightly to the opposite side from the piston 20 by the working oil discharged from the rod-side chamber 2, and as shown in FIG. 2, the first tapered portion 33 of the piston rod 30 is brought into contact with the second tapered portion 43 of the cushion bearing 40.

As the piston rod 30 moves in extension direction and approaches the stroke end, the cushion bearing 40 is inserted into the inside of the bearing receiving portion 50A of the cylinder head 50 from the inserted portion 41. Thus, a cushion passage 5 is formed between the outer circumferential surface of the cushion bearing 40 and the inner circumferential surface of the bearing receiving portion 50A. Because the first tapered portion 33 of the piston rod 30 is in contact with the second tapered portion 43 of the cushion bearing 40, the communication between the first inner-circumference gap 6 and the second inner-circumference gap 7 is shut off. Therefore, the working oil in the rod-side chamber 2 is not discharged through the inside of the cushion bearing 40, but is discharged through the cushion passage 5. Because resistance is imparted to the flow of the working oil discharged from the rod-side chamber 2 through the cushion passage 5, the pressure drop in the rod-side chamber 2 is suppressed, and the piston rod 30 is decelerated. By doing so, the cushioning operation is exhibited at the vicinity of the stroke end when the piston rod 30 moves in extension direction.

When the rod-side chamber 2 is communicated with the hydraulic pump and the bottom-side chamber 3 is communicated with the tank, because the working oil is supplied to the rod-side chamber 2 and the working oil in the bottom-side chamber 3 is discharged to the tank, the piston rod 30 moves in contraction direction.

As shown in FIG. 3, when the piston rod 30 moves in contraction direction from the most extend state, the cushion bearing 40 is moved to the piston 20 side by the working oil supplied to the rod-side chamber 2, and the end surface thereof is brought into contact with the piston 20. The first tapered portion 33 of the piston rod 30 and the second tapered portion 43 of the cushion bearing 40 are separated from each other. Therefore, the working oil supplied from the pump is led to the rod-side chamber 2 through the cushion passage 5 and is led to the rod-side chamber 2 through the first inner-circumference gap 6, the second inner-circumference gap 7, and the groove portion 44 of the cushion bearing 40. Thus, when the piston rod 30 moves in contraction direction from the most extended state, the working oil quickly flows into the rod-side chamber 2, thereby ensuring responsiveness during contraction.

According to the embodiment mentioned above, the advantages described below are afforded.

With the hydraulic cylinder 100, the first tapered portion 33 is formed on the outer circumference of the piston rod 30 so as to be inclined with respect to the center axis, and the second tapered portion 43 is formed on the inner circumference of the cushion bearing 40 so as to be inclined with respect to the center axis. The second tapered portion 43 is brought into contact with the first tapered portion 33 of the piston rod 30, whereby the cushion bearing 40 is positioned with respect to the piston rod 30. As described above, because the first tapered portion 33 functions as the seat surface of the cushion bearing 40 and also as the tapered portion for ensuring the assemblability, it is possible to reduce the difference between the outer diameter of the main body portion 31 of the piston rod 30 and the outer diameter of the screw portion 34 on the tip end side. Therefore, it is possible to increase the diameter of the screw portion 34 to which the piston 20 is fastened and to improve the strength of the piston rod 30.

In addition, because the vertical portion 133B (see FIG. 8) need not be provided on the piston rod 30 as the seat surface of the cushion bearing 40, it is not required to provide a stress relief portion for preventing stress concentration on the piston rod 30. Therefore, because the number of processing steps during production of the piston rod 30 is reduced, the processing thereof can be simplified, and in turn, the manufacturing cost can be reduced.

Next, a modification of the hydraulic cylinder 100 according to this embodiment is illustrated.

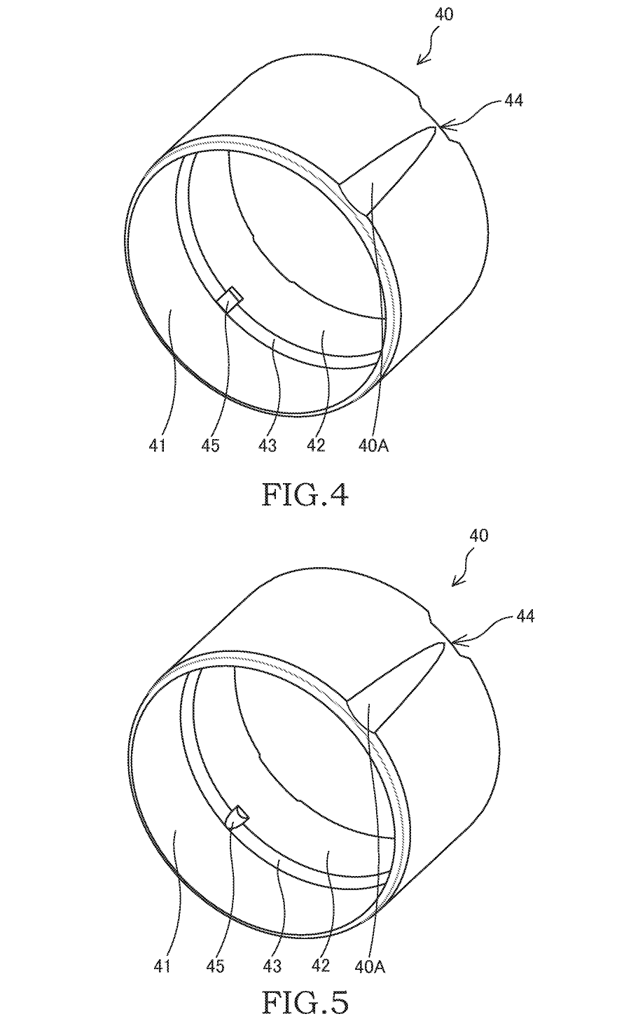

With the configuration in the above-mentioned embodiment, when the piston rod 30 moves in extension direction, the first tapered portion 33 of the piston rod 30 is brought into contact with the second tapered portion 43 of the cushion bearing 40, whereby discharge of the working oil through the inside of the cushion bearing 40 is shut off. Instead of this configuration, as shown in FIGS. 4 and 5, a cut-out portion 45, which allows communication between the first inner-circumference gap 6 and the second inner-circumference gap 7 and imparts resistance to the flow of the working oil passing therethrough, may be formed on the second tapered portion 43 of the cushion bearing 40. The cut-out portion 45 may be formed on the first tapered portion 33 of the piston rod 30 or may be formed on both the first tapered portion 33 of the piston rod 30 and the second tapered portion 43 of the cushion bearing 40.

By forming the cut-out portion 45 on the second tapered portion 43 of the cushion bearing 40, when the piston rod 30 moves in extension direction, the working oil in the rod-side chamber 2 is discharged through the cushion passage 5 and also discharged through the groove portion 44 of the cushion bearing 40, the second inner-circumference gap 7, the cut-out portion 45, and the first inner-circumference gap 6.

Because resistance is also imparted to the flow of the working oil passing through the cut-out portion 45, the cushioning operation is also exhibited by the working oil passing through the inside of the cushion bearing 40. Therefore, by arbitrarily setting the shape of the cut-out portion 45, it is possible to adjust the cushioning characteristic of the hydraulic cylinder 100. For example, as shown in FIG. 4, the cross-section of the cut-out portion 45 perpendicular to the axial direction may have a rectangular shape, or as shown in FIG. 5, the cross-section perpendicular to the axial direction may have a curved surface having an arc-shape. In addition, because it is not required to provide a cushion seal 150 (see FIG. 8), which is provided to impart resistance to the flow of the working oil passing through the inside of the cushion bearing 40, the number of parts can be reduced.

Embodiments of this invention were described above, but the above embodiments are merely examples of applications of this invention, and the technical scope of this invention is not limited to the specific constitutions of the above embodiments.

In the above-mentioned embodiment, although the working oil is used as the working fluid, instead of this configuration, for example, aqueous alternative fluid etc. may be used.

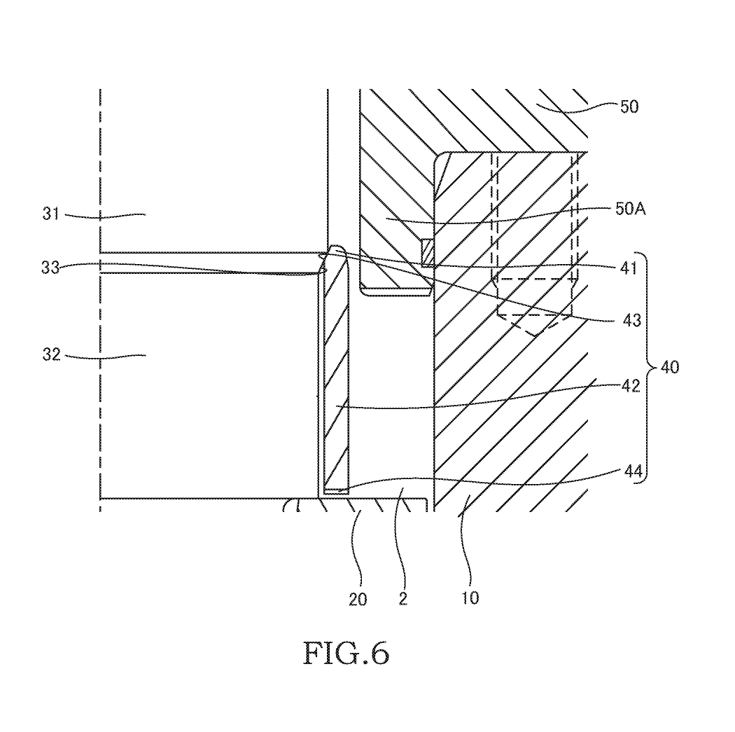

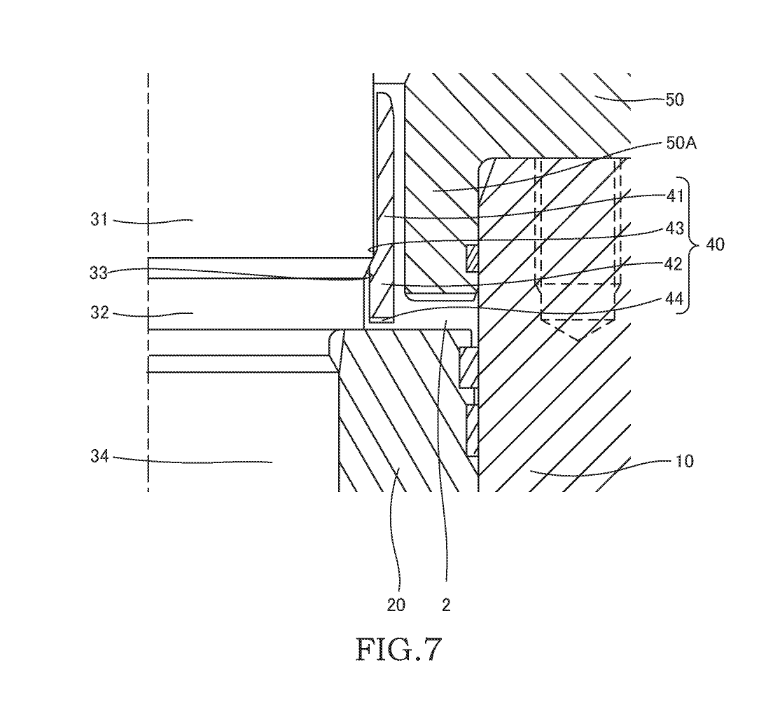

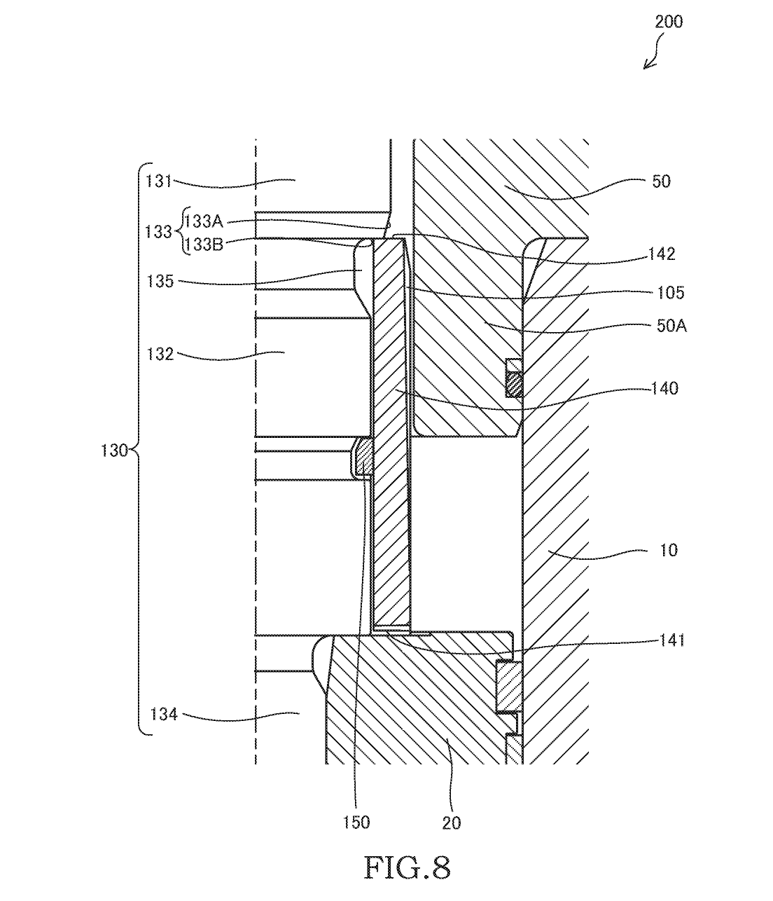

In addition, in the above-mentioned embodiment, as shown in FIG. 2, the second tapered portion 43 of the cushion bearing 40 is formed at the middle part in the axial direction. Instead of this configuration, as shown in FIG. 6, the second tapered portion 43 may be formed closer to the first tapered portion 33 of the piston rod 30, in other words, the second tapered portion 43 may be formed on a tip end portion of the cushion bearing 40 on the front side in the direction in which the cushion bearing 40 is inserted into the bearing receiving portion 50A. In addition, as shown in FIG. 7, the second tapered portion 43 may be formed on the piston 20 side.

In addition, with the configuration in the above-mentioned embodiment, the cushion bearing 40 is provided so as to form a gap with the outer circumferential surface of the piston rod 30 and is floating-supported so as to be slightly movable in the axial direction. Instead of this configuration, a configuration in which the cushion bearing 40 is fixed to the piston rod 30 by being clamped may be employed.

In addition, with the configuration in the above-mentioned embodiment, the bearing receiving portion 50A is provided on the cylinder head 50. Instead of this configuration, the bearing receiving portion 50A may be provided on the inner circumference of the cylinder tube 10. In addition, the bearing receiving portion 50A may be provided as a separate member independent from the cylinder head 50 and the cylinder tube 10.

In addition, in the above-mentioned embodiment, although the tapered groove 40A is formed on the outer circumference of the cushion bearing 40, the tapered groove 40A may not be formed.

This application claims priority based on Japanese Patent Application No. 2013-242981 filed with the Japan Patent Office on Nov. 25, 2013, the entire contents of which are incorporated into this specification.

1. A fluid pressure cylinder in which a piston rod is decelerated by cushion pressure generated at vicinity of a stroke end of the piston rod comprising:
the piston rod having a first tapered portion formed on an outer circumference of the piston rod so as to be inclined with respect to a center axis;
a cylinder tube into which the piston rod is inserted;
a tubular cushion bearing that is provided around the outer circumference of the piston rod;
a bearing receiving portion that allows insertion of the cushion bearing; and
a cushion passage that is formed between the cushion bearing and the bearing receiving portion when the cushion bearing is inserted into inside of the bearing receiving portion at the vicinity of the stroke end and that imparts resistance to flow of working fluid passing through the cushion passage; wherein
the cushion bearing has, on an inner circumference, a contacting portion capable of coming into contacting with the first tapered portion, and
the contacting portion is positioned with respect to the piston rod by being brought into contact with the first tapered portion.

2. The fluid pressure cylinder according to claim 1 further comprising
a piston that is provided on a tip end of the piston rod and slides along an inner circumferential surface of the cylinder tube, wherein
the cushion bearing forms a gap with an outer circumferential surface of the piston rod and is provided so as to be movable in an axial direction between the piston rod and the piston, and
a groove portion is formed on an end surface of the cushion bearing, which is brought into contact with the piston, so as to extend in a radial direction.

3. The fluid pressure cylinder according to claim 2, wherein
a cut-out portion that opens to the gap is formed on at least one of the first tapered portion and the contacting portion.

4. The fluid pressure cylinder according to claim 2, wherein
the cushion bearing further has:
an inserted portion that is inserted into the inside of the bearing receiving portion at the vicinity of the stroke end; and
a positioning portion that is provided between the first tapered portion and the piston, wherein
the contacting portion is provided between the inserted portion and the positioning portion.

5. The fluid pressure cylinder according to claim 4 further comprising
a cylinder head that is provided at an opening end of the cylinder tube and slidably supports the piston rod, wherein
the piston rod has:
a main body portion that is in sliding contact with an inner circumference of the cylinder head, and
a small-diameter portion having a smaller outer diameter than the main body portion; wherein
an inner diameter of the inserted portion is formed so as to be larger than an outer diameter of the main body portion, and
an inner diameter of the positioning portion is formed so as to be larger than the outer diameter of the small-diameter portion.

6. The fluid pressure cylinder according to claim 1, wherein
the contacting portion is a second tapered portion that is inclined with respect to a center axis of the cushion bearing, and
the first tapered portion and the second tapered portion are formed so as to have an equal inclined angle with respect to a center axis of the piston rod.

7. The fluid pressure cylinder according to claim 1, wherein
the contacting portion is provided on a tip end portion of the cushion bearing on a front side in a direction in which the cushion bearing is inserted into the bearing receiving portion.
